(19) United States
(12) Patent Application Publication
(10) Pub. No.: US 2014/0278784 A1
(43) Pub. Date: Sep. 18, 2014

(54) RATING SYSTEM FOR WINE EXPLORATION

(71) Applicant: L18 HOLDINGS, INC., New York, NY (US)

(72) Inventor: Philip J. K. James, New York, NY (US)

(73) Assignee: L18 Holdings, Inc., New York, NY (US)

(21) Appl. No.: 13/840,748

(22) Filed: Mar. 15, 2013

(51) Int. Cl. G06Q 30/02

(52) U.S. Cl. CPC G06Q 30/0203; G06Q 30/0282
USPC 705/7.32

(57) ABSTRACT

Some embodiments described herein generally relate to a rating system for wine exploration. A rating system including questions designed to determine a preference of the user regarding one or more specific characteristics of wine, such as, a taste characteristic. The rating system may be provided to a user, for example, by a web-based interface. Samples of wine may be provided to the user each of which is samples ranked for the at least one characteristic of wine. The user may respond to the questions about the wine, and those responses may be analyzed to determine the user's preference for the specific characteristics. A user profile may be created based on the analyzed responses and the profile may be used to select wines for the user. Such wines may be selected and shipped periodically, for example, as part of a wine club.

### FIELD

The present invention relates to systems and methods for wine exploration. More specifically, the present invention relates to systems and methods for determining user interest in particular characteristics of wine and selecting wines for the user based on the interest.

### BACKGROUND

The wine industry has experienced an increase in the number of wineries, brands, wine styles, and retail outlets which have made different wines available to the consumer. There is a seemingly endless selection of wines each differing from the others by type, price, quality, region of origin, and/or taste. For example, same type of wine may vary greatly from one producer to another, depending on the specific materials used in the production process, the area where it was produced, the age of the product, the year it was produced, etc.

Users, many of which are unfamiliar with wine, are often faced with an extensive array of wines from which to choose. Thus, selecting and purchasing wine can be an intimidating undertaking for many potential users. As a result, many users purchase wines without much knowledge of wine styles and taste characteristics, which may lead them to have a bad buying experience. The results can vary from the user discounting all wines of a particular type or from a particular winery or the user concluding they do not like wine. Users may identify one type or brand of wine they like, and may never attempt to explore or discover new wines and different styles.

The large variety of wines available on the market has resulted in an entire culture centered around evaluating the wines in a “tasting” or “sampling” process. In order to facilitate this process, many wine producers in wine regions all over the world offer tastings of their wine. Depending on the country or region, tasting at the winery may incur a small charge to allow the producer to cover costs. Typically, however, traveling to particular wineries or producers to sample the product where it is produced is impractical. Thus, users often rely on professional tasters and ranking systems for guidance in selecting a product rather than sampling the product themselves. However, such wine rankings only evaluate a small number of available wines and are based only upon characteristics of the wine subjectively perceived by experts. The rankings cannot to inform a user whether they will like a particular wine.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

The present invention relates to systems and methods for wine exploration. More specifically, the present invention relates to systems and methods for determining user interest in particular characteristics of wine and selecting wines for the user based on the interest.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In one embodiment, the technologies described herein include methods of selecting at least one wine for a user. Such methods may include creating a plurality of queries designed to determine a preference of the user regarding at least one characteristic of wine, providing a plurality of samples to a user, each of the samples ranked for the at least one characteristic of wine, receiving from the user an answer to at least one of the plurality of queries, analyzing the answer to determine the preference of the user regarding the at least one characteristic, creating, by a processor, a user profile based on the at least one characteristic and selecting at least one wine for the user based on the user profile.

In another embodiment, the technologies described herein include a computer-readable storage medium having computer-executable instructions stored thereon that are executable by a processor to cause a computer to perform the methods of selecting at least one wine for a user.

In another embodiment, the technologies described herein include methods of determining a wine profile for a particular user. Such methods include creating a plurality of profiles, each of the profiles including data related to at least one characteristic of wine, creating a tasting kit including a plurality of samples of different wines based on the at least one characteristic of each of the samples of different wines, developing a rating scheme including a series of queries designed to elicit responses from a user related to a level of interest of the user in the at least one characteristic of each of the samples of different wines and analyzing, by a processor, the responses to determine one of the profiles user.

In another embodiment, the technologies described herein include systems for wine exploration including a computer-readable storage medium having a database and a computer program stored thereon and a processor configured to: create a plurality of profiles, each of the profiles including data related to at least one characteristic of wine, create a tasting kit including a plurality of samples of different wines based on the at least one characteristic of each of the samples of different wines, develop a rating scheme including a series of queries designed to elicit responses from a user related to a level of interest of the user in the at least one characteristic of each of the samples of different wines and analyze, by a processor, the responses to determine one of the profiles user.

As is described more fully below, the aspects of the invention provide a mechanism to provide wines to consumers based on the consumers' interest in the wine without requiring the consumers to purchase full bottles of wines they may or may not like. As may be understood, this provides additional marketing and distribution opportunities which are not currently available in the art.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE FIGURES

To further clarify the above and other advantages and features of the present invention, a more particular description of the embodiments illustrated in these figures will be rendered by reference to specific embodiments thereof which are illustrated in the appended figures. It is appreciated that these figures depict only typical embodiments of the invention and are, therefore, not to be considered limiting of its scope. The invention will be described and explained with additional specificity and detail through the use of the accompanying figures in which:

FIG. 1 is a schematic diagram illustrating a system that may be used in determining user interest in particular characteristics of wine and selecting wines for the user based on interest; and

FIG. 2 is a flow diagram illustrating a method of selecting at least one wine for a consumer.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Some embodiments described herein generally relate to a rating system for wine exploration, which may be useful in selecting wines for a particular user. As used herein, the term “user,” may refer to any individual person, group of people, or association that purchases, uses, or consumes goods, such as wine. Each of the wine profiles may include information related to one or more characteristics associated with the wine. For example, such characteristic may also be referred to as a quality or attribute possessed by the wine, and may be determined objectively or subjectively. The characteristics may be used as criteria to distinguish the wine from other wines, and to determine a profile for the user. Examples of such characteristics include, but are not limited to, body, fruity, earthy, oaky, acidity, brightness, and/or dryness. The wines may be determined to be within a range of each of the characteristics. Such ranges may include, for example, full body to light body, fruity to not fruity, earthy to not earthy, oaky to not oaky, and/or acidic to round.

The embodiments disclosed herein provide an interactive experience for wine exploration for the user and enable selection of wines based on the user's preferences. A user that does not know what kinds of wine he or she likes best and is overwhelmed by the idea of navigating so many regions, varietals, etc. is provided with a simplified way of rating wines and obtaining wines based on their own unique profile. Exploration of wine by the user is made easier and more efficient by guiding the user through a tasting experience where their feedback in response to the wines they taste will help the system to build a profile for them. This profile will be used to determine what wines to send them in the future and the process will repeat, getting more and more accurate over time and expanding the user's knowledge.

This all takes place via a website, with interactive tools that guide the person through tasting and rating.

Reference will now be made in detail to the embodiments of the invention, examples of which are illustrated in the accompanying drawings. Wherever possible, the same reference numbers will be used throughout the drawings to refer to the same or like parts.

FIG. 1 is a block diagram illustrating an environment capable of performing aspects of the invention. As shown in FIG. 1, aspects of the environment provide a system 100 for wine exploration by a user which includes a means for processing electronic data, such as a processor 102, a means for storing information readable and accessible by the processor 102, such as a database 104, and a means for communicating with the Internet or a computer network, such as a communications module 106. The system 100 may include software, such as an operating system, and other peripheral devices for performing the functions described herein.

The processor 102 may be any device capable of executing a set of instructions that specify actions to be taken. For example, the processor 102 may include a central processing unit (CPU). The processor 102 may be in communication with the database 104.

The database 104 may be implemented in a computer-readable medium and may include an organized collection of data that can be used as described herein. The computer-readable medium in which the database 104 is implemented may alternately or additionally include a computer-readable code (e.g., software) including a set of instructions that are executed by the processor 102 to perform one or more of the acts or operations associated with the methods described herein.

The computer-readable medium may be any available media that may be accessed by a general purpose or special purpose computer. By way of example, and not limitation, such computer-readable media may include random access memory (RAM), read only memory (ROM), electrically erasable programmable read only memory (EEPROM), compact disc-ROM (CD-ROM) or other optical disk storage, magnetic disk storage or other magnetic storage devices, flash memory or other solid state storage devices, or any other medium which may be used to carry or store desired program code means in the form of computer-executable instructions.

The computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing acts and/or operations of the methods disclosed herein. The particular sequence of such executable instructions or associated data structures represents examples of corresponding acts for implementing the functions described therein.

The computer-readable medium may be included, for example, in the system 100 where it may be accessed by the processor 102. The computer-readable medium may be used to store, for example, data relating to one or more characteristics of wine (hereinafter “characteristics(s)”) relevant in determining a user's preference for or interest in wine. The characteristics may include, but are not limited to, taste or flavor, aroma, appearance or color, aftertaste (or “finish”), integration, and expressiveness. As a non-limiting example, the characteristics may include body, fruity, earthy, oaky, acidity, brightness, and/or dryness.

The computer-readable medium may be used to store, for example, data relating to one or more profiles, each of the profiles associated with at least one of the characteristics. For example, a first profile may be associated with a user preference in a range of the at least one of the following characteristics: full body to light body and fruity to earthy/oaky. The profiles for red wines may be associated with fruity to earthy and the profiles for white wines may be associated with fruity to oaky. By way of example and not limitation, a first profile may be associated with wines having any body (low, mid, or full) and any fruity to earthy characteristics; a second profile may be associated with low or full body (but not mid body) and fruity or earthy (but not in between); a third profile may be associated with full-bodied fruity or low-bodied earthy; a fourth profile may be associated with full to mid body, with full being preferred, and fruity to mid-earthy, with fruity being preferred; a fifth profile may be associated with low body and any range of fruity to mid-earthy; a sixth profile may be associated with low body and any range of fruity to earthy; a seventh profile may be associated with low to mid body, with low body being preferred, and earthy; an eighth profile may be associated with mid body and midrange fruity to earthy; and a ninth profile may have no preference for body or fruity/earthy.

The computer-readable medium may be used to store, for example, data relating available wines, including the characteristics of samples of wines and wines available for purchase. The characteristics of the samples of wines and the available wines may be predetermined using conventional objective or subjective methods.

The computer-readable medium may be used to store, for example, data relating to a rating system to evaluate the user interest in or preference for the characteristics of the samples. The rating system may include including a series of queries designed to elicit responses from a user related to the level of interest or preference of the user in the at least one characteristic of each of the samples of different wines.

The computer-readable medium may be used to store, for example, registration data for each of the users. Such registration data may include identifying information for the user, such as name, e-mail address, a username, password, physical address, telephone number, or any other indicia that may be used to identify the user or verify the user's identify.

The system 100 may utilize the communications module 106 to enable communication between the processor 102 and the Internet or another computer network. The communications module 106 may include, for example, a modem, an ethernet card, a universal serial bus (USB) interface card, a WLAN interface, or any other network interface device.

The processor 102 may be configured to send the queries to the user and to receive the responses from the user, which may be transmitted through at least one communication network 108. For example, the processor 102 may receive the responses via the communications module 106. The response may include any information capable of being collected through the communication network 108. For example, the rating system including the queries may be provided as a web-based interface that may be accessed by the user through the communication network 108. A user device 110 may be used by the user to access the rating system and to transmit the responses to the processor 102 via the communication network 108. For example, a user interface may be provided with an interface, such as an online interface, which enables the user to request the samples and to utilize the rating system. The communication network 108 from which the information is obtained from the user may include, for example, a telecommunications network, a global network, a national network, a local network, a LAN, a WAN, a PAN, a WLAN, and/or a WPAN.

The responses may be analyzed and compiled to create at least one data set including data related to the user's preference for the characteristics. As will be discussed in greater detail, the responses may include information relevant to determining the user's interest in or preference for at least one of the predetermined characteristics of each of the samples of wine. For example, the responses may be analyzed by the processor 102 which determine the profile for the user based on the responses.

The responses, or profile determined from the responses, may then be analyzed by the system 100 and may be compared with the characteristics of available wine to select wines that the user may like based on the indication by the user of a preference for particular characteristics. As a non-limiting example, the responses may be analyzed using an algorithm stored on the computer-readable medium.

An individual may also make alterations to the profile manually, or by logging in to the system 100 and entering information related to preferences for subsequently tasted wines. For example, the individual may receive an order including wines selected based on the profile. After the user tastes those wines, the user may provide responses about which wines were preferred. The response may be transmitted to the system 100 and the profile for the user may be modified.

Using the rating system may, therefore, enable a provider of wine to tailor the selection of wines to particular users. The system 100 may be used to provide wines based on a periodic basis, such as a weekly or monthly wine club. Alternately, a list of wines may be generated and provided to the user, or wines may be selected and sent to the user based on a request by the user.

The system 100 may be configured to generate an electronic message including information related to the profile determined for the user. The electronic message may be transmitted to the user by the system 100. The electronic message may include, for example, information related to the profile, such as personality traits, wine preferences, regions or types associated with the profile, as well as recommendations of wines that the user may want to request or try and food that may accompany such wines. The electronic message may be generated by the system 100 and transmitted to the user device 110 via the communication network 108, or may be made accessible to the user on the web-based interface.

FIG. 2 illustrates a method of selecting at least one wine for a user. The method may include act 202, providing a plurality of samples to a user, each of the samples ranked for the at least one characteristic of wine. Each of the samples may include an amount of wine that is substantially reduced in comparison to a full-size bottle of wine, which is typically about 750 mL. For example, a sample kit may be created based on an order placed by the user. Optionally, the user may be a registered customer that has created an account. For example, the user may create the account using the interface provided to the user. To create the account, the user may enter one or more of a name, e-mail address, username, password, physical address, telephone number, or the like.

The plurality of samples provided to the user may be a plurality of bottles of wine, each differing from the others in at least one characteristic. The samples may be created using decanting wine such as those described in U.S. patent application Ser. No. 12/972,071, the entire disclosure of which is hereby incorporated by reference. For example, wine from a source bottle may be decanted into sample bottles in a chamber substantially free of oxygen. The wine may be transferred such that the wine in the sample bottles remains unchanged or substantially unchanged from the wine in the source bottle. Thus, the characteristics of the samples of wine provided to the user may be preserved.

The plurality of samples may include different types or different varietals, such as red wine and white wine. As a non-limiting example, the plurality of samples may include between 2 and 20 samples and, more particularly, between 4 and 18 samples and, yet more particularly, between about 6 and about 14 samples and, more particularly still, between about 8 and about 10 samples. The samples may include any number of red wines and any number of white wines.

The samples may be provided as a sampler kit containing mini bottles of wine, each of the mini bottles containing a different wine selected for one or more particular characteristics. By way of example and not limitation, the sampler kit may include two mini bottles containing different white wines and four mini bottles containing different red wines. For example, the mini bottles may each include a total volume of wine of less than about 250 mL, or between about 10 mL and about 100 mL, or about 50 mL.

In addition to the samples of wine, the sampler kit may include instructions guiding the user to the interface, such as a website, where the user may access the rating system to rate the wine. The sampler kit may also include a tasting mat to assist the user during the rating experience.

Providing the samples to the user enables a lower barrier to entry and also to get more data faster. But the ultimate goal is for the user to have full bottles of wine to enjoy. The profile and the tasting are means to that end.

Referring still to FIG. 2, the method may include act 204, creating a plurality of queries designed to determine a preference of the user regarding at least one characteristic of wine. The plurality of queries may comprise a rating scheme, which may be provided to the user and used to determine the user's interest in or preference for particular wines.

After the user receives the samples, the user may be provided with the rating system, which walks the user through tasting each of the samples. For example, the rating system may be provided to the user using a web-based interface that will prompt the user to answer. For example, the sample kit may include instructions guiding the user to a website where the user may access the rating system. When the user accesses the website, the user may be provided with information about the rating system and the service, including information about the samples and the technology used to package the samples and to determine the user's profile. The user may also be provided with instructions on how to perform and complete the wine-tasting process, such as optimal temperatures or glassware for sampling wine. Such information may enable consistent and reliable results and may also assist the user in enjoying the wine-tasting process.

The method may include act 206, receiving from the user an answer to at least one of the plurality of queries. As one example, the user may be instructed to separately taste two of the samples and may be asked to determine which of the two of the samples is preferred over the other. The responses may include, for example, a preference for a first wine in comparison to a second, wherein the first and second wines have different characteristics. The indication by the user that a wine having particular characteristics is preferred over another wine may enable determination of the characteristics the user prefers.

The method may include act 208, analyzing the answers to determine the preference of the user regarding the one or more characteristics. For example, a user may compare samples of a full-bodied wine and low-bodied wine, as well as samples of an oaky wine and a fruity wine, and the user may indicate a preference for the full-bodied wine and a preference for the fruity wine. The user may, thus, provide only information about which of the samples of wine they like, dislike, or have no preference for, and the characteristics preferred by the user may be determined without the user having to provide particular information about the characteristics. In addition to indicating a preference for the first wine over the second wine, the user may indicate a range of preference for the first wine over the second wine.

The user's preference may be correlated with one or more different characteristics of the two samples to narrow the user's preference for those characteristics. For example, one of the two wines may have increased body (i.e., more full body) in comparison to the other of the two wines. If the user selects the wine with the increased body, it may be determined that the user prefers wines with a full or full to mid body over wines with a low or low to mid body wine. If the user selects the wine with the lower body, it may be determined that the user prefers wines with a low or low to mid body over wines with a full or full to mid-body wine.

If the user indicates no preference for either wine, it may be determined that the user does not have a preference for full or low body. The user may then be asked if the reason they have no preference is they liked both of the wines or disliked both of the wines. If the user indicates they liked both wines, they will be asked to which degree they liked one over the other. This series of queries will enable information about the user's preference for the different characteristics of the wines even if the user did not have a strong preference, as well as providing information about the degree to which the user prefers or does not prefer the different characteristics.

The wines may differ in one or more of the characteristics, such as low to full body, fruity to not fruity, earthy to not earthy, oaky to not oaky, and the like. The rating system includes a flow of queries designed to narrow the characteristics preferred by the user to determine the profile for the user. Each of the queries may be designed to elicit a response from the user about a preference for one of the samples over another sample. In addition, the queries may be designed to elicit a response from the user about a preference for one or more of the characteristics. As a non-limiting example, the user may be asked which of the two wines is preferred or tastes better. The rating system provides an understanding of primary and secondary wine types that the user likes or is interested in trying. In this way, the rating system provides a way of quantifying the user's specific, subjective tastes.

Each sample wine has been evaluated and categorized according to the characteristics, which may be recorded as wine-related metadata. This metadata may, for example, include the following categories: “body” (Low, Mid, or Full) and the fruity to earthy/oaky axis (Fruity, Mid, Oaky for white wines; Fruity, Mid, Earthy for red wines).

The method may further include act 210, creating a user profile based on the at least one characteristic. The responses provided by the user may be used to narrow the user's preferences to a particular set of characteristics. The set of characteristics may be correlated with or mapped to one or more of the profiles previously discussed. Each of the profiles includes a combination of a red wine profile and a white wine profile, which may be determined separately during the tasting using the rating system, but are presented to the user as a single profile.

Using the rating process, one of the profiles that best corresponds to the user may be determined by converting relative preferences of specific wines with respect to one another to weighted likes and dislikes in each metadata category. Scores may be determined based on the metadata and primary and second profiles may be selected for the user.

For example, the rating system may be used to narrow the user's preference to wines having any body (low, mid, or full) and any fruity to earthy characteristics, and the user may be correlated with the first profile, or the rating system may be used to narrow the user's preference to wines having low body and any range of fruity to mid-earthy and the user may be correlated with the fifth profile.

After the profile has been determined based on information gathered by the rating system, the personalization of wine selection may be explained to the user.

The method may also include act 212, selecting at least one wine for the user based on the user profile. The primary and/or secondary profile for the user may be used to select one or more wines based on the metadata associated with those wines. The wines may be selected based on the profile and may be periodically shipped to the user. The wines may be provided to the user as full-size bottles including a total volume of wine of, for example, 750 mL. Any number of bottles of the wines may be provided to the user, such as a single bottle or a case including 12 bottles. For example, the wines may be shipped to the user on a weekly, monthly, bi-monthly, quarterly, or yearly basis. The wines may be shipped to the user using the information provided during the registration process. In this way, the method may be used to provide a wine club that the user joins by registering.

If the user does not use the rating system, the selected wines will be those that appeal to the widest range of wine drinkers. When the user is provided with the wine, the user will be asked to utilize the rating system to rate the provided wines. The user may provide information about the at least one characteristic of the selected wines and the preference of the user regarding the characteristics may be re-correlated with the profiles to update the profile. The profile may, thus, be periodically updated depending on the answers provided by the user, which may account for changes in the user's tastes or may resolve inaccuracies.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a “computer-readable medium.” Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method of selecting at least one wine for a user, comprising:
creating a plurality of queries designed to determine a preference of the user regarding at least one characteristic of wine;
providing a plurality of samples to a user, each of the samples ranked for the at least one characteristic of wine;
receiving from the user an answer to at least one of the plurality of queries;
analyzing the answer to determine the preference of the user regarding the at least one characteristic;
creating, by a processor, a user profile based on the at least one characteristic; and
selecting at least one wine for the user based on the user profile.

2. The method of claim 1, wherein creating a plurality of queries designed to determine a preference of the user regarding the at least one characteristic of wine comprises creating a plurality of queries based on predetermined characteristics of the plurality of samples.

3. The method of claim 1, wherein receiving from the user an answer to at least one of the plurality of queries comprises prompting the user to provide the answer using a web-based interface.

4. The method of claim 3, wherein prompting the user to provide the answer comprises prompting the user to answer at least one of the plurality of queries designed to determine a preference for one of the samples of wine over another of the samples of wine, the one of the samples of wine differing from another of the samples of wine in the at least one characteristic.

5. The method of claim 1, further comprising predetermining a plurality of user profiles, each of the user profiles including the at least one characteristic of wine.

6. The method of claim 5, wherein predetermining a plurality of user profiles comprises designing each of the user profiles based on at least one of body, fruitiness, oakiness, and earthiness of the wine.

7. The method of claim 5, wherein creating a user profile based on the at least one characteristic comprises correlating the preference of the user regarding the at least one characteristic with the plurality of user profiles to determine at least one of the user profiles including the at least one characteristic.

8. The method of claim 6, further comprising providing the at least one wine to the user on a periodic basis.

9. The method of claim 7, further comprising:
enabling the user to provide information about the at least one characteristic of the at least one wine selected for the user; and
re-correlating, by the processor, the preference of the user regarding the at least one characteristic with the plurality of user profiles to determine at least one of the user profiles including the at least one characteristic.

10. A computer-readable storage medium having computer-executable instructions stored thereon that are executable by a processor to cause a computer to perform the method of claim 1.

11. A method of determining a wine profile for a particular user, comprising:
creating a plurality of profiles, each of the profiles including data related to at least one characteristic of wine;
creating a tasting kit including a plurality of samples of different wines based on the at least one characteristic of each of the samples of different wines;
developing a rating scheme including a series of queries designed to elicit responses from a user related to a level of interest of the user in the at least one characteristic of each of the samples of different wines; and
analyzing, by a processor, the responses to determine one of the profiles user.

12. The method of claim 11, wherein creating a plurality of user profiles comprises creating each of the profiles based on at least one of a range of full body to light body, a range of fruity to not fruity, a range of earthy to not earthy, and a range of oaky to not oaky.

13. The method of claim 11, wherein the data related to the at least one characteristic indicates a preference of the at least one characteristic over at least another characteristic.

14. The method of claim 11, wherein developing a rating scheme comprises evaluating a plurality of wines according to the at least one characteristic and categorizing each of the wines according to metadata corresponding to at least one of the following categories:
low body, mid body, or full body;
fruity, mid fruity/oaky, or oaky; and
fruity, mid fruity/earthy, or earthy.

15. The method of claim 14, wherein metadata corresponding to fruity, mid fruity/oaky, or oaky is associated with white wines, and wherein metadata corresponding to fruity, mid fruity/earthy, or earthy is associated with red wines.

16. The method of claim 11, wherein analyzing the responses to determine one of the profiles user comprises correlating the level of interest of the user in the at least one characteristic of each of the samples of different wines with the data of the plurality of profiles.

17. The method of claim 11, wherein analyzing the responses to determine one of the profiles user comprises correlating the level of interest of the user in the at least one characteristic of each of the samples of different wines with the data of the plurality of profiles.

18. A system for wine exploration, comprising:
a computer-readable storage medium having a database and a computer program stored thereon; and
a processor configured to:
create a plurality of profiles, each of the profiles including data related to at least one characteristic of wine;
creating a tasting kit including a plurality of samples of different wines based on the at least one characteristic of each of the samples of different wines;
developing a rating scheme including a series of queries designed to elicit responses from a user related to a level of interest of the user in the at least one characteristic of each of the samples of different wines; and
analyzing, by a processor, the responses to determine one of the profiles user.

19. The method of claim 17, wherein creating a tasting kit comprises decanting each of the samples of different wines from a source bottle into sample bottles in a chamber substantially free of oxygen.

20. The method of claim 17, wherein analyzing the responses to determine one of the profiles user comprises determining a set of characteristics for the user by the level of interest of the user in the set of characteristics and mapping the set of characteristics to those including in at least one of the profiles.
